(19) United States
(12) Patent Application Publication
(10) Pub. No.: US 2005/0025366 A1
(43) Pub. Date: Feb. 3, 2005

(54) Method for saving a specific image in a video codec

(75) Inventor: Kyung Ah Jeong, Seoul (KR)

Correspondence Address: HARNESS, DICKEY & PIERCE, P.L.C., P.O. BOX 828, BLOOMFIELD HILLS, MI, 48303, US

(73) Assignee: C and S Technology Co., Ltd., Seoul (KR)

(21) Appl. No.: 10/899,763

(22) Filed: Jul. 27, 2004

(30) Foreign Application Priority Data
Jul. 28, 2003 (KR) 10-2003-51936

(51) Int. Cl. G06K 9/36

(52) U.S. Cl. 382/232

(57) ABSTRACT

A specific image is saved in accordance with a video CODEC operated by the multi-frame structure. The method copies and saves a specific image in the process of compressing or decompressing the image of a videophone or a multimedia terminal. Each process utilizes first and second memory spaces of size commensurate with the size of images, and uses alternately two memory spaces as the area for a current image being coded or decoded and the area for a previous image. When the copy request of a specific image is issued during decompressing or compressing of the arbitrary (n)^{th} frame, the image desired to be copied, corresponding to the previous image in the compressing or decompressing process of the (n+1)^{th} frame, is treated as the image saved in said 1^{st} memory space, thereupon the compressing or decompressing process of the (n+2)^{th} frame is processed with respect to the 3^{rd} memory space.

### BACKGROUND OF THE INVENTION

1. Field of the Invention

The present invention relates to a method for saving a specific image in a video CODEC. In more detail, it relates to a method for copying and saving a specific image in the process of compressing or decompressing the image of a videophone or a multimedia terminal.

2. Description of the Related Art

FIG. 1 shows that the correlation between an image and a memory used in the process of a conventional decompressing process. An identical correlation as the decompressing process is established in a conventional compressing process, and the processing flow of compressing is depicted in FIG. 3.

In the video CODEC using the motion vector such as H.261, H262, and MPEG, it is necessary to utilize the information related to a previous image in the process of compressing/decompressing. Therefore, two different memory spaces are assigned in accordance with the size of images, and a current image being decoded and a previous image occupy two memory spaces alternately. By reason of only two memory spaces, the prior art should copy a specific image into other memory area to save said specific image, as shown in FIG. 2. More particularly, it should be started to copy the specific image into other memory space after completing the compressing/decompressing of an image.

Accordingly, the conventional method requires to quit the corresponding CODEC process so as to save a specific image, and wait until finishing the copy of the image for restarting the CODEC process (refer to FIGS. 2 and 4). If the CODEC process is performed before finishing the copy process, the image desired to copy can be overwritten by an another image. Therefore, the conventional saving method requires large amount of time to process, even though the processing time varies from the speed of a data bus. Furthermore when external storage device is utilized, the required processing time amount is tremendous.

Consequently, the conventional method as mentioned above for saving a specific image decreases the efficiency for the compressing/decompressing process.

### SUMMARY OF THE INVENTION

It is the object of the present invention to remove the above-described prior art problem. The present invention provide a method for saving a specific image in the process of a video CODEC, which is capable of removing the time wasted for coping said specific image and reducing the number of memory access, thereby decreasing the power consumption.

To accomplish the above object, the present intention provides a method for a video CODEC operated by the multi-frame structure, more particularly, a method for copying and saving a specific image during the compressing or decompressing process. Each process utilizes a first and a second memory space assigned as much as the size of images, and uses alternately two memory spaces as the area for a current image being coded or decoded and the area for a previous image.

When the copy request of a specific image is issued during decompressing or compressing of the arbitrary (n)^{th} frame, the image desired to copy, which is corresponded to the previous image in the compressing or decompressing process of the (n+1)^{th} frame, is treated as the image saved in said 1^{st} memory space, thereupon the compressing or decompressing process of the (n+2)^{th} frame is processed with respect to the 3^{rd} memory space.

### BRIEF DESCRIPTION OF THE DRAWINGS

FIG. 1 is a diagram depicting the correlation between an image and a memory space used for a decompressing process in accordance with the prior art.

FIG. 2 is a diagram depicting the correlation between an image and a memory space used for a decompressing process in case of copying a specific image in accordance with the prior art.

FIG. 3 is a flow chart depicting the conventional processing flow of compressing.

FIG. 4 is a flow chart depicting the processing flow of compressing in case of copying a specific image in accordance with the prior art.

FIG. 5 is a diagram depicting the correlation between an image and a memory space used for a decompressing process in case of saving a specific image in accordance with the present invention.

FIG. 6 is a flow chart depicting one embodiment for saving the image inputted by a camera in accordance with the present invention.

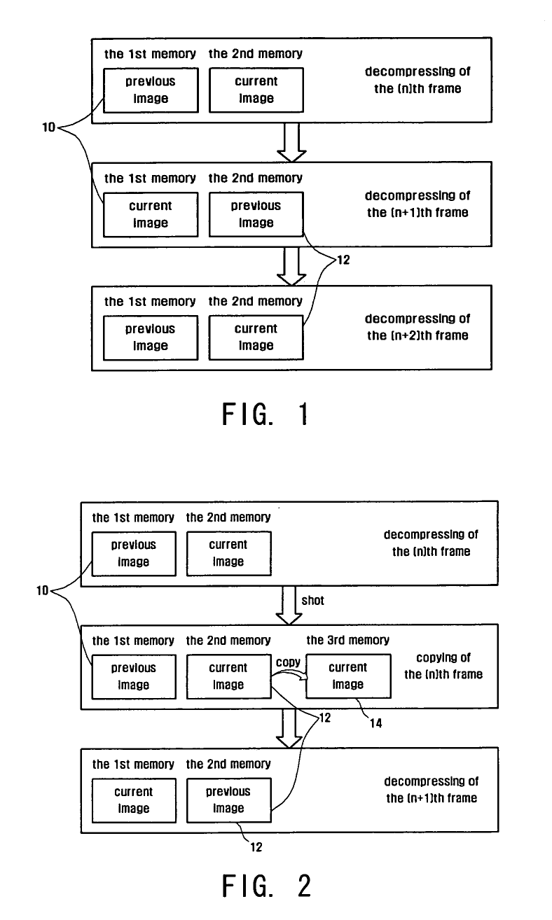

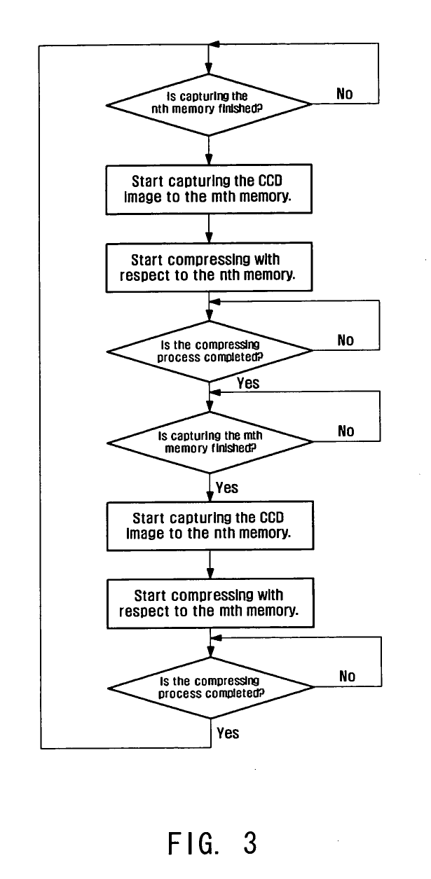

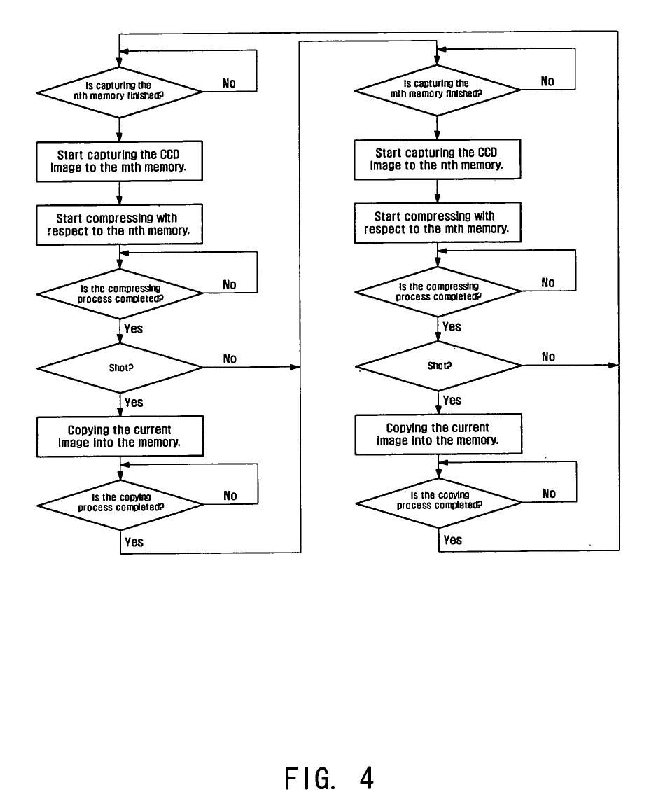

### DESCRIPTION OF THE NUMERALS ON THE MAIN PARTS OF THE DRAWINGS

10, 12, 14: a memory

### DETAILED DESCRIPTION OF THE EMBODIMENTS

Hereinafter, referring to appended drawings, the structures and the operation procedures of the embodiments of the present invention are described in detail.

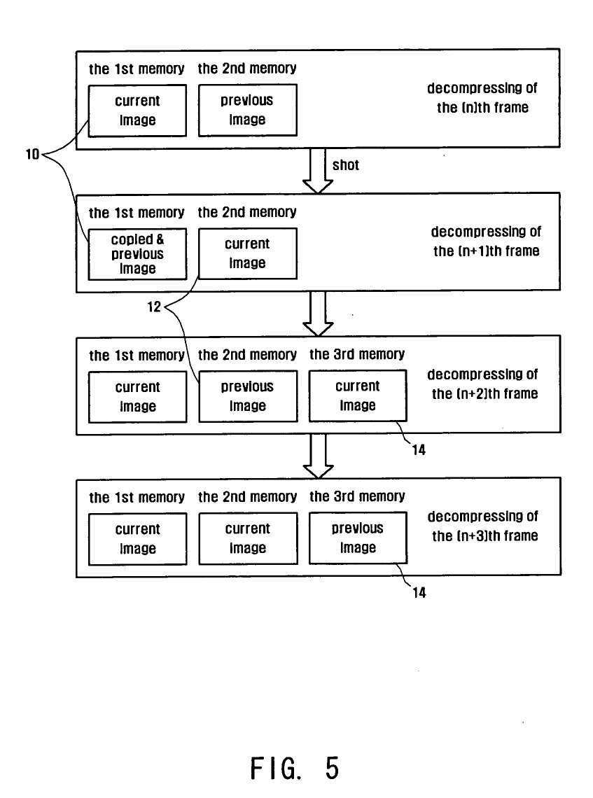

FIG. 5 is a diagram depicting the correlation between an image and a memory space, and showing the method for copying and saving an image without any time delay in a video CODEC process.

If a copy request is issued while a decompressing process of the (n)^{th} frame, the image desired to copy in the decompressing process of the (n+1)^{th} frame is corresponded to the previous image. The decompressing stage of the (n+1)^{th} frame is progressed without involving the copy process as shown in FIG. 5. Namely, the decompressing stage of the (n+2)^{th} frame is progressed by treating as the image desired to copy, which was the previous image in (n+1)^{th} frame, is saved in the 1^{st} memory.

In a conventional case, the current image in the decompressing stage of the (n+2)^{th} frame is stored in the 1^{st} memory. However, in the present invention, the decompressing stage of the (n+2)^{th} frame is processed with respect to a 3^{rd} memory because the image desired to copy has been already saved in the 1^{st} memory. Accordingly, it is possible to save the image desired to copy in the 1^{st} memory without any extra processing, and process the decompressing process with respect to the 3^{rd} memory without time delay.

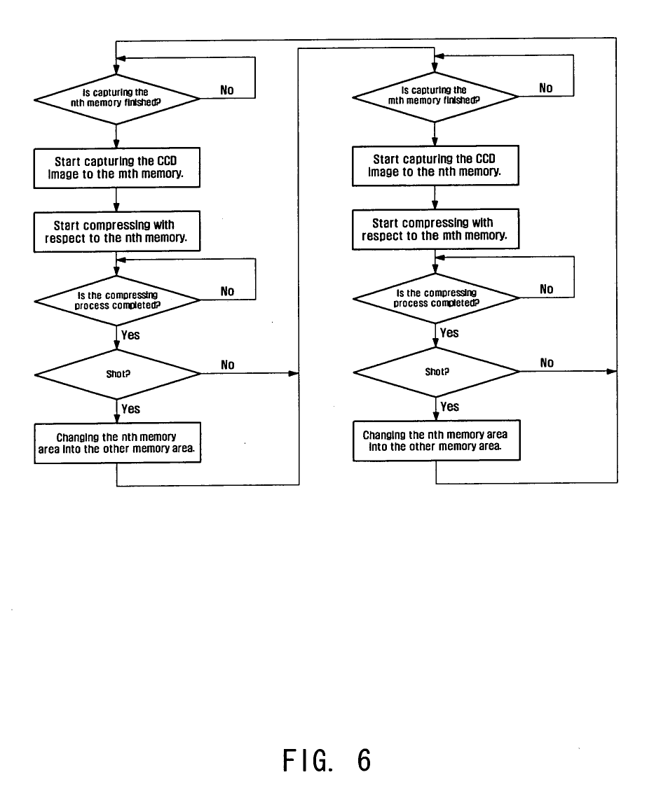

FIG. 6 is a flow chart depicting a compressing embodiment that saves the image inputted by a camera in accordance with the present invention.

At least three memory areas are needed for simultaneous capturing and encoding the image inputted by a camera. As explained in the decompressing process, the memory area is switched alternatively according to the progress of the compressing process of each frame, and the method for saving the image captured is same as the image decoded. Namely, other memory area is used so as to prevent the image captured from overwriting on the image desired to copy.

Since the above-described method for saving an image does not consume the time for copying the image, the CODEC process is not influenced by the time that takes for copying the image into an external storage media taking relatively long time for copying the image. The copy process can be eliminated when the image is saved in an internal memory instead of the external storage device.

Furthermore, when we assume the amount of image data is 8 bits per pixel, the number of memory access for reading and writing is estimated as [2×image size (in pixel)] bytes. Consequently, by eliminating the copy process, the power consumption can be decreased as much as reducing the number of memory access.

Since those having ordinary knowledge and skill in the art of the present invention will recognize additional modifications and applications within the scope thereof, the present invention is not limited to the embodiments and drawings described above.

1. In a method for saving a specific image in a video CODEC operated by the multi-frame structure, more particularly, in a method for copying and saving a specific image during the compressing or decompressing process, which utilizes a first and a second memory space assigned as much as the size of images, and uses alternately two memory spaces as the area for a current image being coded or decoded and the area for a previous image, wherein said method for saving a specific image in a video CODEC is characterized in that:
when the copy request of a specific image is issued during decompressing or compressing of the arbitrary (n)^{th} frame, the image desired to copy, which is corresponded to the previous image in the compressing or decompressing process of the (n+1)^{th} frame, is treated as the image saved in said 1^{st} memory space, thereupon the compressing or decompressing process of the (n+2)^{th} frame is processed with respect to the 3^{rd} memory space.

2. A method for saving a specific image in a video CODEC according to claim 1, wherein said image is one among an image coded, an image decoded, and an image captured by CCD.

3. A method for saving a specific image in a video CODEC according to claim 1, wherein said the compressing process utilizes at least three frames for saving said image.

4. A method for saving a specific image in a video CODEC according to claim. 1, wherein said the decompressing process utilizes at least three frames for saving said image.

5. A method for saving a specific image in a video CODEC according to claim 1, wherein capturing the CCD image utilizes at least three frames for saving said image.

6. A method for saving a specific image in a video CODEC according to claim 1, the storage space for saving the image decoded is changed to an arbitrary memory space, and a specific image desired to copy is saved in the previous memory in (n+1)^{th} frame.

7. A method for saving a specific image in a video CODEC according to claim 1, the storage space for saving the image coded or captured by CCD is changed to an arbitrary memory space, and a specific image desired to copy is saved in the previous memory in (n+1)^{th} frame.
